(19) United States
(12) Patent Application Publication
(10) Pub. No.: US 2019/0078446 A1
(43) Pub. Date: Mar. 14, 2019

(54) BLADE OF A TURBOMACHINE, INCLUDING A COOLING CHANNEL AND A DISPLACEMENT BODY SITUATED THEREIN, AS WELL AS A METHOD FOR MANUFACTURING

(71) Applicant: MTU Aero Engines AG, Muenchen (DE)

(72) Inventors: Richard Scharl, Karlsfeld (DE); Johannes Casper, Muenchen (DE); Alexander Ladewig, Bad Wiessee (DE); Christian Liebl, Bockhorn (DE); Steffen SCHLOTHAUER, Erdweg (DE); Klaus Semmler, Dachau (DE)

(21) Appl. No.: 16/126,836

(22) Filed: Sep. 10, 2018

(30) Foreign Application Priority Data
Sep. 11, 2017 (DE) 102017215940.5

(51) Int. Cl. F01D 5/18

(52) U.S. Cl. CPC F01D 5/189; F05D 2220/323; F05D 2230/53; F05D 2240/30; F05D 2260/221; F05D 2250/141; F05D 2250/75; F05D 2250/121; F05D 2250/12; F05D 2250/131; F05D 2250/14; F05D 2250/231; F05D 2250/132

(57) ABSTRACT

A blade of a turbomachine is provided, including at least one cooling channel in the interior of the blade for cooling the blade with the aid of a fluid flowing through the cooling channel, the cooling channel having at least one inlet and at least one outlet, between which the cooling channel extends along its longitudinal axis, and the cooling channel being radially delimited by at least one wall, at least one displacement body being situated in the cooling channel, so that an annular or tubular gap between the displacement body and the wall of the cooling channel results in the area of the displacement body/bodies, which is available for the through-flow of the fluid, or at least two or multiple subchannels being formed in the area of the displacement body/bodies. The invention also relates to a method for manufacturing a corresponding blade.

This claims the benefit of German Patent Application DE102017215940.5, filed Sep. 11, 2017 and hereby incorporated by reference herein.

The present invention relates to a blade of a turbomachine, for example a stationary gas turbine or an aircraft engine, and in particular a turbine blade, preferably a turbine blade of a high-pressure turbine, the blade including at least one cooling channel in the interior of the blade for cooling the blade with the aid of a fluid flowing through the cooling channel The present invention furthermore relates to a method for manufacturing a blade of this type.

### BACKGROUND

In turbomachines, such as stationary gas turbines or aircraft engines, it is known to provide blades, in particular blades for the area of the high-pressure turbine, with cooling channels to be able to conduct a cooling fluid through the at least one cooling channel of the blade for the purpose of reducing the temperature load of the blade. In this way, a preferably high operating temperature of the turbomachine may be implemented for a blade made from a given material, or more alternatives for a possible material for manufacturing the blade are available for a certain operating temperature of the turbomachine, without damage to the blade or the material of the blade occurring during operation due to the temperature load.

Examples of turbine blades of this type are described, for example in US 2016/0312617 A1 or DE 10 2015 213 090 A1. Although high operating temperatures of the turbomachines may already be effectuated with the aid of the known turbine blades, there remains a need to improve the cooling of blades in turbomachines either to be able to further increase the operating temperature of the turbomachine or to be able to use other materials for the blades. To operate the turbomachines efficiently, it is also advantageous if a low demand exists for cooling fluid, for example cooling air.

The described aspects of the importance of the cooling of blades are all the more applicable if blades are designed to be integral with a rotor disk as a so-called blisk, since this limits the material selection for the blades, and the cooling of the blade and the vane becomes correspondingly more important.

### SUMMARY OF THE INVENTION

It is an object of the present invention to provide a blade or blisk for a turbomachine, which facilitates a better and, in particular more efficient, cooling of the blade and the vane during the operation of the turbomachine. At the same time, the blade should be reliably operable and easy to manufacture.

### Technical Approach

The present invention provides a blade or blisk as well as a method for manufacturing a blade of a turbomachine.

For the sake of simplicity, only blades are mentioned below, this term, however, also covering so-called blisks, i.e. blades designed to be integral with rotor disks.

According to the present invention, it is proposed, in a blade for a turbomachine, which includes at least one cooling channel in the interior of the blade for cooling the blade with the aid of a fluid flowing through the cooling channel, to situate at least one displacement body in the cooling channel, so that an annular or tubular gap between the displacement body and the wall of the cooling channel results in the area of the one or more displacement bodies, which is available for the through-flow of the fluid. This achieves the fact that the cooling fluid comes into better contact with the wall of the cooling channel to be cooled or the adjacent material of the blade which is to be cooled by the cooling fluid, for example cooling air. As a result, the heat transfer to the cooling fluid may be improved, and a more effective and more efficient cooling of the blade takes place, so that the temperature load of the blade and/or the consumption of the cooling fluid may be reduced.

As an alternative to forming an annular or tubular gap between the displacement body and the wall of the cooling channel, the displacement body/bodies may also be formed in the cooling channel in such a way that at least two or more subchannels are formed, which also cause the cooling fluid flowing through the cooling channel to be provided efficiently to the areas of the blade to be cooled.

The displacement body or multiple displacement bodies may be situated in the cooling channel of a blade of a turbomachine in different ways to achieve a better heat transfer from the wall of the cooling channel to the through-flowing cooling fluid.

For example, the at least one displacement body may be situated in the area of the axial and/or radial center of the cooling channel The axial direction is understood to be the longitudinal extension of the cooling channel along the flow direction of the cooling fluid, while the radial direction represents a direction transverse to the axial direction or longitudinal direction of the cooling channel Accordingly, the at least one displacement body may thus be situated in the middle of the cooling channel with respect to the longitudinal direction or the axial direction and/or with respect to the center axis of the cooling channel, i.e. the radial direction.

The displacement body may extend along the center axis of the cooling channel, in particular coaxially to the center axis of the cooling channel This results in a uniform distribution of the through-flowing cooling fluid along the circumference of the cooling channel.

The displacement body may be situated entirely inside the cooling channel It may not touch, in particular, the wall of the cooling channel and/or it may be held via one or multiple webs, which in this case are not part of the displacement body.

The gap width of the gap formed between the displacement body and the wall of the cooling channel and the maximum diameter or the flow cross section of a subchannel formed through the displacement body may be constant along the longitudinal axis of the cooling channel or be varied along the longitudinal axis of the cooling channel Moreover, combinations are also conceivable, so that the gap width of the gap and the maximum diameter or the flow cross section of a subchannel may be different in subareas, while the gap width of the gap and the maximum diameter or the flow cross section of the subchannel remain constant over the longitudinal axis. The gap width of the gap and the maximum diameter or the flow cross section of a subchannel may remain constant over the entire length of the cooling channel or at least over a large subarea of the cooling channel, for example over at least 90% of the cooling channel.

In addition to a variation of the gap width of the gap between the displacement body and the wall of the cooling channel along the longitudinal axis of the cooling channel, the gap width may also be designed to be varied or remain constant around the longitudinal axis along the circumference of the cooling channel A variation of the gap width along the circumference of the cooling channel may be used to allow more or less cooling fluid to flow along the wall of the cooling channel in certain areas of the cooling channel, for example depending on the proximity to the surface of the vane.

The displacement body may be designed and situated in the cooling channel in such a way that the flow cross section of the cooling channel is reduced in the area of the displacement body.

The displacement body may be enclosed or trapped in the blade, it being able to be, in particular, unremovably, i.e. nondestructively removably, enclosed or trapped in the blade.

The displacement body itself may, in turn, have cooling channels, so-called displacement body channels, which may also be connected via overflow openings to the cooling channel in which the displacement body is situated.

The displacement body may furthermore be formed by a honeycomb, matrix or lattice structure, so that both the use of materials and the weight of the blade may be kept low. In the design of the displacement body having a honeycomb, matrix or lattice structure, the cavities of the honeycomb, matrix or lattice structure may be filled with a filling material which has, for example, a low density. Alternatively or additionally, the displacement body may be provided with a closed shell, for example with a metal shell, to prevent the penetration of cooling fluid. The closed shell may be completely tightly sealed by manufacturing material after the cavities have been filled with filling material or after the cavities have been emptied. Alternatively, the formation of a partial shell or a partially open shell is also conceivable.

The closed shell may define an inner volume which encompasses or is a cavity and/or which has a lower density compared to the blade material.

The closed shell and/or the inner volume may be situated entirely inside the cooling channel.

The cross-sectional shapes of the cooling channel and/or one of the subchannels and/or the displacement body may be implemented in different ways, for example, as round, circular, oval, angular, quadrangular, hexagonal shapes or arbitrary free shapes. The cross-sectional shapes of the cooling channel and the displacement body may be identical or different.

The arrangement of a displacement body in a cooling channel may be characterized in that a shared cooling inlet is provided for all cooling fluid paths through the cooling channel, i.e. for an annular or tubular gap and/or multiple subchannels. Accordingly, if multiple subchannels are formed, they may open into a shared cooling channel.

If subchannels are formed, the at least one displacement body may be shaped and/or situated in the cooling channel in such a way that the subchannels are formed on the sides of the cooling channel which are situated closer to a surface of the blade than one of the other sides of the cooling channel In particular, the subchannels may be situated in such a way that at least a larger portion of their surface is situated on the side(s) of the cooling channel which is/are closer to a surface of the blade than the sides of the cooling channel without or having a smaller surface portion of one of the subchannels.

The cooling channel and/or the subchannels of the cooling channel may be designed in such a way that the maximum diameter of the cooling channel or of a subchannel is smaller than the longitudinal extension of the cooling channel and/or the subchannel

The cooling channel may extend through the blade, in particular in a meandering manner, so that large areas of the blade may be cooled by the cooling fluid flowing through the cooling channel

In this or in other specific embodiments, the displacement body may be bent according to a bent course of the channel.

The manufacture of a corresponding blade may take place, in particular using a generative or additive manufacturing method, in which the blade is built up layer by layer from a powder material. In this way, it is easily possible to form the displacement body in a cooling channel.

Selective laser beam melting or selective electron beam melting may preferably be used as the generative or additive manufacturing method.

### BRIEF DESCRIPTION OF THE DRAWINGS

The attached drawings show the following in a purely schematic way:

FIG. 1 shows a perspective representation of a turbine blade according to the present invention;

FIG. 2 shows a longitudinal section of the turbine blade from FIG. 1, with a sectional view according to Arrows A;

FIG. 3 shows a cross section of the turbine blade from FIG. 1, with a sectional view according to Arrows B;

FIG. 4 shows another specific embodiment of a turbine blade according to the representation in FIG. 3; and

FIG. 5 shows another specific embodiment of a turbine blade according to the representation in FIG. 3.

### DETAILED DESCRIPTION

Additional advantages, characteristics and features of the present invention are apparent from the following detailed description of the exemplary embodiments. However, the present invention is not limited to these exemplary embodiments.

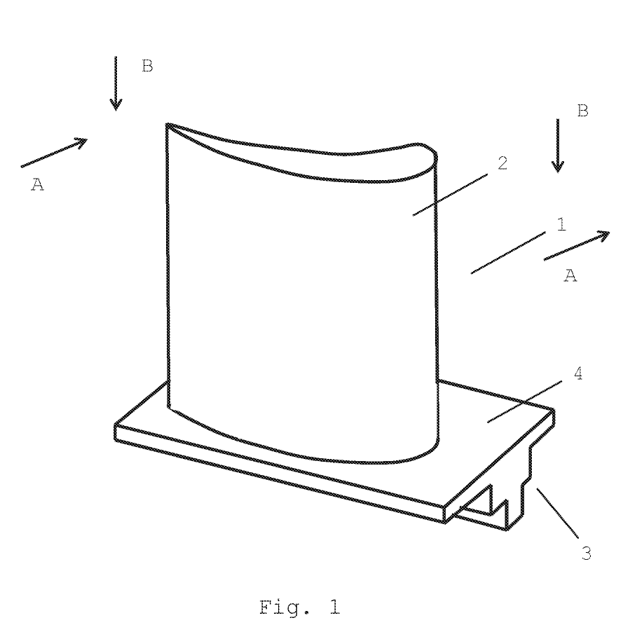

FIG. 1 shows a perspective representation of a turbine blade 1, in which the present invention is implemented. Turbine blade 1, which may be used, for example, in the high-pressure turbine area of a turbomachine, includes a vane 2 as well as a blade root 3, a shroud 4 being formed between vane 2 and blade root 3.

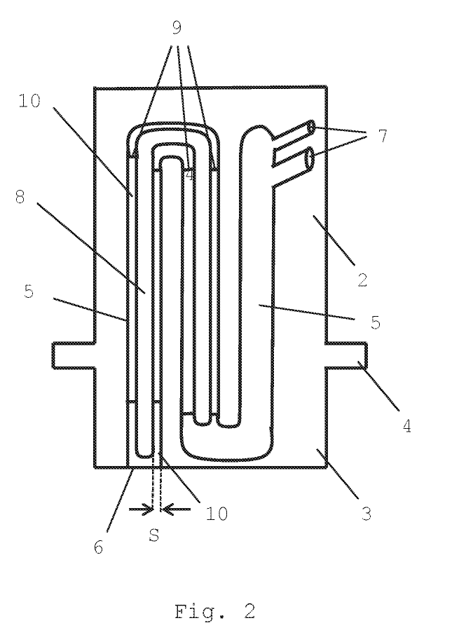

As is apparent from the sectional view in FIG. 2, a cooling channel 5 is formed in the interior of turbine blade 1, which has a cooling channel inlet 6 in the area of blade root 3 and two cooling channel outlets 7 in the area of the blade tip of vane 2.

Cooling channel 5 initially runs in a meandering manner from cooling channel inlet 6 in the area of blade root 3 to the upper end of vane 2 and, after a 180° deflection, it runs from the upper end of vane 2 back to blade root 3, where, after another 180° deflection, cooling channel 5 again runs in the direction of the upper end of vane 2. In the area of the upper end of vane 2, at the blade tip, cooling channel 5 has multiple cooling channel outlets 7, through which a fluid, which is used to cool turbine blade 1, for example cooling air, may exit cooling channel 5.

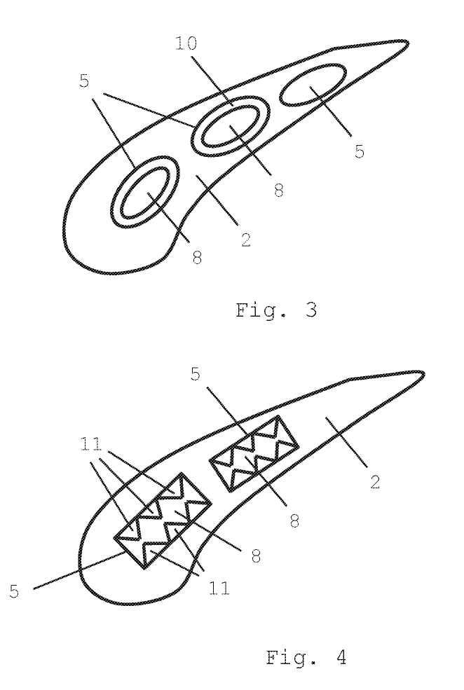

To achieve the fact that the cooling fluid or the cooling air preferably passes along the wall of cooling channel 5 radially delimiting cooling channel 5, for the purpose of facilitating a corresponding heat transfer there with the aid of the material of vane 2 heated during operation, a displacement body 8 is provided in cooling channel 5, which, in the illustrated exemplary embodiment in FIGS. 2 and 3, extends in the middle along the longitudinal axis of cooling channel 5.

As is apparent in FIG. 2, in the illustrated exemplary embodiment, displacement body 8 is not provided over the entire length of cooling channel 5 but only in a subsection of cooling channel 5, in the subsection, in which cooling channel 5 runs from blade root 3 to upper end of vane 2 at the blade tip and back again to blade root 3. However, it is, of course, also possible to provide displacement body 8 over other areas along the longitudinal axis of cooling channel 5 or to situate multiple displacement bodies 8 one after the other along cooling channel 5.

In the example in FIG. 2, displacement body 8 is bent according to a course of cooling channel 5, is situated entirely within cooling channel 5 and is not nondestructibly removable therefrom.

Displacement body 8, which, in the illustrated exemplary embodiment, has a cylindrical basic shape with an oval cross section (see FIG. 3) and also has a U shape according to the 180° deflection of cooling channel 5 in the area of the blade tip and is situated via holding webs 9 in the middle of cooling channel 5 at a distance from the radial delimiting wall of cooling channel 5. Holding webs 9 may be situated spaced apart from each other along the circumference of displacement body 8 as well as spaced apart from each other along the longitudinal direction of displacement body 8.

Displacement body 8 is thus situated spaced apart from the wall of cooling channel 5 in such a way that an annular gap 10 results, which surrounds displacement body 8 and is formed between displacement body 8 and the wall of cooling channel 5. Annular gap 10 extends in a tubular manner along the longitudinal direction of displacement body 8 and cooling channel 5. The cooling fluid flowing through the cooling channel may flow through cooling channel 5 only in the area of annular gap 10, due to displacement body 8, so that a large portion of the through-flowing cooling fluid flows in the direct vicinity of the wall of cooling channel 5, where it is able to effectuate a corresponding heat transfer.

FIG. 3 shows a cross-sectional view of the arrangement of displacement body 8, which has an oval cross-sectional shape, in the first two subsections of cooling channel 5, which extend from blade root 3 to the blade tip of vane 2 and back again. It is apparent in the illustration in FIG. 3 that cooling channel 5 also has an oval cross-sectional shape. However, it is, of course, possible that both cooling channel 5 and displacement body 8 have other cross-sectional shapes, for example a circular cross-sectional shape, angular, in particular quadrangular, rectangular, square, polygonal or arbitrarily shaped cross-sectional shapes. The cross-sectional shape of displacement body 8 may correspond to the cross-sectional shape of cooling channel 5, or the cross-sectional shapes of cooling channel 5 and displacement body 8 may be different.

In the illustrated exemplary embodiment in FIG. 3, annular gap 10 is uniformly designed to have a constant annular gap width S circumferentially around displacement body 8. However, displacement body 8 and cooling channel 5 may also be shaped in such a way, and/or displacement body 8 may be situated in cooling channel 5 in such a way that annular gap width S is variable circumferentially around displacement body 8. For example, displacement body 8 may not be situated with its central longitudinal axis coaxial to the central longitudinal axis of cooling channel 5, as in the illustrated exemplary embodiment in FIG. 3, but rather situated eccentrically to the center axis of cooling channel 5.

Moreover, it is also possible that gap width S of gap 10 between displacement body 8 and the wall of cooling channel 5 varies along the longitudinal axis of cooling channel 5. FIG. 2 shows that gap width S is held constant in the subsections extending in a straight line from blade root 3 to the blade tip. In the area of the 180° deflection of cooling channel 5 in the upper area of vane 2, at the blade tip, gap width S is, however, partially different than gap width S in the straight subsections of cooling channel 5.

In a cross-sectional view comparable to the cross-sectional view in FIG. 3, FIG. 4 shows another specific embodiment of a turbine blade 1 according to the present invention, in which cooling channel 5 has a rectangular cross-sectional shape. In the specific embodiment in FIG. 4, a displacement body 8 is used in cooling channel 5, which is designed with a polygonal shape in cross section having multiple triangular indentations along the longitudinal sides of a rectangular basic shape. In the arrangement of displacement body 8 in cooling channel 5, due to the triangular indentations, multiple subchannels 11 are formed on the longitudinal sides of the rectangular cross-sectional shape of cooling channel 5, which make it possible for the cooling fluid flowing through cooling channel 5 to pass essentially along the surfaces of the wall of cooling channel 5 which are situated adjacent to the outsides of vane 2, i.e. along the longitudinal sides of cross-sectionally rectangular cooling channel 5 in the illustrated exemplary embodiment. As a result, the cooling fluid flowing through the cooling channel is concentrated on the wall areas of cooling channel 5 which are adjacent to the temperature-loaded outsides of vane 2, i.e. the longitudinal sides of the rectangular cooling channel This permits a particularly efficient use of the cooling fluid.

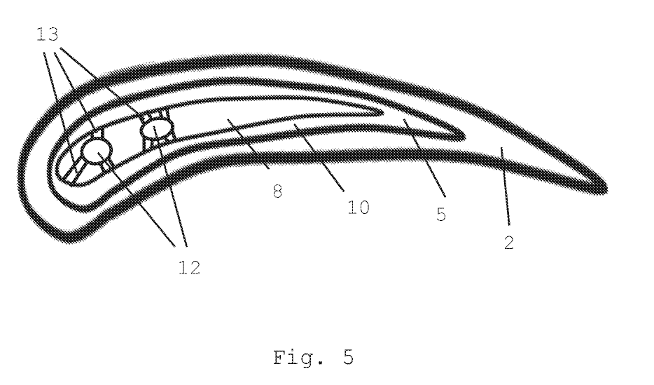

In a cross-sectional view comparable to the cross-sectional view in FIG. 3, FIG. 5 shows another specific embodiment of a blade according to the present invention, in which a cooling channel 5 is formed centrally over a wide area of the cross section in the manner of a hollow blade, in which a displacement body 8 is again situated, so that an annular gap 10 results circumferentially around the displacement body Channels 12 (displacement body channels) are again situated in displacement body 8 itself, which are connected to annular gap 10 and cooling channel 5 via overflow openings 13. The displacement body channels are formed essentially axially along the cooling channel longitudinal axis and radially with respect to a turbomachine, while the overflow openings run transversely thereto in the radial direction with respect to the cooling channel axis. Accordingly, a variety of structures are formed through which cooling channels pass and which facilitate an efficient cooling of the structures.

Although the present invention was described in detail on the basis of exemplary embodiments, it is as a matter of course to those skilled in the art that the present invention is not limited to these exemplary embodiments, but instead modifications are possible in such a way that individual features may be omitted or different combinations of features may be implemented, without departing from the scope of protection of the attached claims. In particular, the above description includes all combinations of the individual features shown in the different exemplary embodiments, so that individual features described only in connection with one exemplary embodiment may also be used in other exemplary embodiments or in combinations of individual features not explicitly illustrated.

### LIST OF REFERENCE NUMERALS

1 turbine blade
2 vane
3 blade root
4 shroud
5 cooling channel
6 cooling channel inlet
7 cooling channel outlet
8 displacement body
9 holding web
10 gap
11 subchannel
12 displacement body channels
13 overflow openings
S gap width

What is claimed is:

1. A blade of a turbomachine, the blade comprising:
at least one cooling channel in an interior of the blade for cooling the blade with the aid of a fluid flowing through the cooling channel, the cooling channel having at least one inlet and at least one outlet, the cooling channel extend between the at least one inlet and the at least one outlet along a longitudinal axis, and the cooling channel being radially delimited by at least one wall; and
at least one displacement body situated in the cooling channel, so that an annular or tubular gap between the displacement body and the at least one wall of the cooling channel results in an area of the displacement body, the annular or tubular gap being available for through-flow of the fluid, or so that at least two subchannels are formed in the area of the displacement body.

2. The blade as recited in claim 1 wherein the at least one displacement body is situated at an axial or radial center of the cooling channel along a center axis of the cooling channel, or the at least one displacement body is situated entirely inside the cooling channel.

3. The blade as recited in claim 2 wherein the at least one displacement body is situated coaxially to the cooling channel.

4. The blade as recited in claim 1 wherein the at least one displacement body is situated entirely inside the cooling channel and not touching the wall of the cooling channel or is held via at least one web.

5. The blade as recited in claim 1 wherein a gap width of the gap between the displacement body and the wall of the cooling channel, or a maximum diameter of one or each of the subchannels, is varied along the longitudinal axis of the cooling channel or is uniform at least in subareas.

6. The blade as recited in claim 5 wherein the gap width or the maximum diameter is uniform over at least 90% of the length of the displacement body.

7. The blade as recited in claim 6 wherein the gap width or the maximum diameter is uniform over an entirety of the length of the displacement body.

8. The blade as recited in claim 1 wherein a gap width of the gap between the displacement body and the wall of the cooling channel is varied along a circumference of the cooling channel or the displacement body reduces a flow cross section of the cooling channel.

9. The blade as recited in claim 1 wherein a gap width of the gap between the displacement body and the wall of the cooling channel remains the same along a circumference of the cooling channel or the displacement body reduces a flow cross section of the cooling channel.

10. The blade as recited in claim 1 wherein the displacement body is unremovably enclosed or trapped within the blade.

11. The blade as recited in claim 1 wherein the displacement body includes at least one displacement body channel for conducting cooling air and connected to the cooling channel.

12. The blade as recited in claim 11 wherein the at least one displacement body channel has at least one overflow opening.

13. The blade as recited in claim 1 wherein the displacement body has a honeycomb, matrix or lattice structure, or the displacement body is provided with a closed shell defining an inner volume.

14. The blade as recited in claim 13 wherein the closed shell or the inner volume are situated entirely inside the cooling channel or the inner volume includes a cavity or has a lesser density compared to the blade material.

15. The blade as recited in claim 1 wherein a cross-sectional shape of a circumference of the cooling channel or the subchannel or the displacement body is selected from the group consisting of round, circular, oval, angular, quadrangular, hexagonal shape and arbitrary free shapes.

16. The blade as recited in claim 1 wherein at least two of the subchannels open into a shared cooling channel or have a shared cooling channel inlet.

17. The blade as recited in claim 1 wherein the displacement body is situated in the cooling channel in such a way that the subchannels are formed with a large portion of their surface on a side of the cooling channel situated closer to a surface of the blade than an other side without or having a smaller surface portion of the subchannels.

18. The blade as recited in claim 1 wherein a longitudinal extension of the cooling channel or the subchannels is greater than a maximum diameter of the cooling channel or of one or each of the sub channels.

19. The blade as recited in claim 1 wherein the cooling channel extends in a meandering manner through the blade, or the displacement body is bent according to a bent course of the channel.

20. A method for manufacturing a blade of a turbomachine as recited in claim 1, the blade being manufactured using a generative method.

21. The method as recited in claim 20 wherein the generative method is selective electron beam melting or laser beam melting.
